(19) United States
(12) Patent Application Publication
(10) Pub. No.: US 2011/0078436 A1
(43) Pub. Date: Mar. 31, 2011

(54) COMMUNICATION APPARATUS, METHOD FOR CONTROLLING COMMUNICATION APPARATUS AND STORAGE MEDIUM

(75) Inventor: Kei Sato, Kawasaki-shi (JP)

(73) Assignee: CANON KABUSHIKI KAISHA, Tokyo (JP)

(21) Appl. No.: 12/891,641

(22) Filed: Sep. 27, 2010

(30) Foreign Application Priority Data
Sep. 30, 2009 (JP) 2009-228651

(51) Int. Cl. H04L 29/06

(52) U.S. Cl. 713/151

(57) ABSTRACT

A control method for controlling an apparatus for performing IPsec communication, and performing negotiation for generating IPsec SA includes performing the negotiation by proposing all combinations of an encryption algorithm, a hash algorithm, and a DH group to a counter apparatus, extracting a combination, which is selected by the counter apparatus, out of all the combinations in a case where the IPsec SA has been successfully generated by the negotiation, storing and using the extracted one combination as an IKE determined value.

### BACKGROUND OF THE INVENTION

1. Field of the Invention

The present invention relates to a communication apparatus, a method for controlling a communication apparatus, and a storage medium.

2. Description of the Related Art

In recent years, as security consciousness in a computer network increases, various secure protocols have been proposed. One of them is Internet Protocol Security (IPsec) that provides secure communication in an Internet Protocol (IP) layer serving as a network layer in an Open System Interconnection (OSI) reference model.

In the IPsec, security setting between communication apparatuses as to what encryption algorithm is used for encrypted communication is implemented by Security Association (SA). A security policy indicating that encrypted communication is performed/not performed for each of apparatuses that communicate with each other is implemented by Security Policy (SP). The SA can be automatically generated for each of apparatuses that perform IPsec communication by using Internet Key Exchange (IKE) serving as a key exchange protocol.

In the IKE, IPsec SA is generated through procedures in two stages. First, in a phase 1 serving as a first stage of the IKE, Internet Security Association Key Management Protocol (ISAKMP) SA is negotiated between the apparatuses that communicate with each other. The ISAKMP SA is a definition of an encryption algorithm or a key used in encrypted communication provided in a phase 2 serving as a second stage of the IKE. In the subsequent phase 2, the IPsec SA is negotiated by encrypted communication using the ISAKMP SA between the apparatuses that communicate with each other.

A period elapsed for generating again the ISAKMP SA and the IPsec SA being used can also be designated in addition to an encryption algorithm and authentication data for the ISAKMP SA. When the above-mentioned period has elapsed, the IPsec SA currently used is discarded, and negotiation is performed again between the apparatuses using the IKE, to generate the ISAKMP SA or the IPsec SA again.

In the IPsec communication, if the IPsec SA is not generated between the apparatuses, communication in an IP protocol cannot be performed. Therefore, it is important to match set values of the ISAKMP and the IPsec between the apparatuses.

In devices that provide an IPsec function, a user has been required to set an encryption algorithm used for communication in each of the devices and perform negotiation by the IKE to match the encryption algorithms used between the apparatuses.

In the IKE protocol, an initiator that proposes an algorithm can propose a plurality of algorithms. A responder that accepts a proposal in the IKE protocol selects one of the algorithms, to determine an algorithm used between the devices.

Conventional technology of encrypted communication includes Japanese Patent Laid-Open No. 2004-032502. However, Japanese Patent Laid-Open No. 2004-032502 is for general encrypted communication. In order to apply the technology to IPsec, therefore, a particular protocol is to be mounted in addition to a standard protocol of the IPsec. Therefore, a device of a communication partner is to also match the particular protocol, so that the communication partner is limited.

As another method for solving a problem, a setting value set is previously prepared for a user in Microsoft Windows (Trademark). However, a combination of the setting value set can differ depending on a manufacturer that develops a communication apparatus. If the use of the setting value set is prohibited when a new encryption algorithm appears and when the encryption intensity of an old algorithm is reduced, the set value set can be changed. The present invention cannot realize the above-mentioned case.

As described above, in the IPsec and the IKE, there are a wide variety of parameters that are to be designated by the user. If any one of parameters does not match the other parameters, the IKE is unsuccessfully negotiated, so that communication becomes impossible. Therefore, a method for the user to easily set the parameters with little failure is demanded.

### SUMMARY OF THE INVENTION

According to an aspect of the present invention, an apparatus includes a communication unit configured to perform IPsec communication, and an execution unit configured to perform negotiation for generating IPsec SA, in which the execution unit includes a negotiation unit configured to perform a negotiation by proposing all combinations of an encryption algorithm, a hash algorithm, and a DH group to a counter apparatus, and an extracting unit configured to extract a combination, which is selected by the counter apparatus, out of all the combinations in a case where it has succeeded in generating the IPsec SA by the negotiation, and a storage unit configured to store the extracted combination as an IKE determined value, and in which the communication unit performs IPsec communication with the counter apparatus using the encryption algorithm, the hash algorithm, and the DH group.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a module configuration of an encrypted communication apparatus in an exemplary embodiment.

FIG. 2 is a flowchart illustrating IPsec processing in the exemplary embodiment.

FIG. 3 is a flowchart illustrating IKE processing in the exemplary embodiment.

### DESCRIPTION OF THE EMBODIMENTS

Various exemplary embodiments, features, and aspects of the invention will be described in detail below with reference to the drawings.

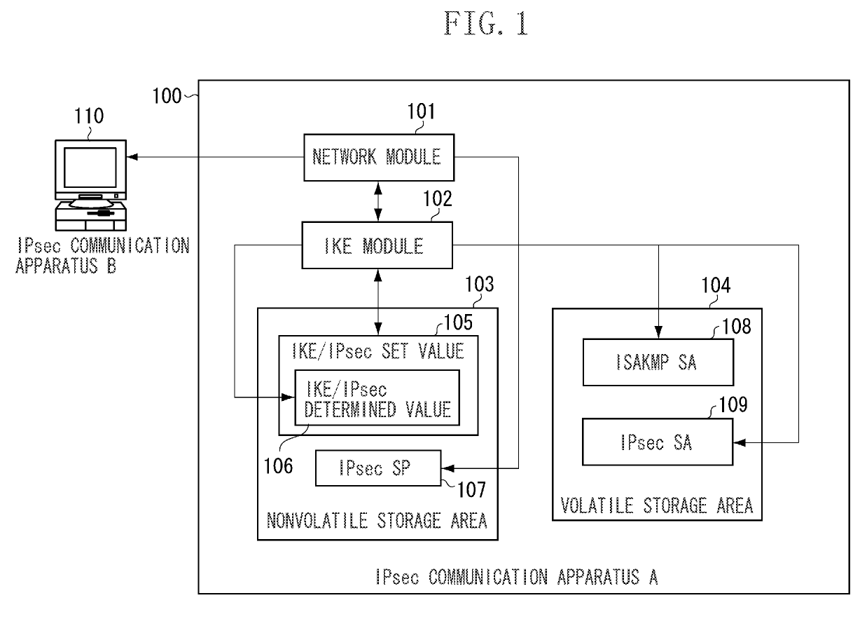

A first exemplary embodiment will be described below. FIG. 1 illustrates an IPsec communication apparatus A 100 and an IPsec communication apparatus B 110 serving as a counter apparatus, which can perform Internet Protocol Security (IPsec) communication with each other. As illustrated in FIG. 1, the IPsec communication apparatus A 100 mainly includes a network module 101, an Internet Key Exchange (IKE) module 102, and a nonvolatile storage area 103 and a volatile storage area 104 that serve as storage units. The network module 101 and the IKE module 102 are implemented by a central processing unit (CPU) provided in the IPsec communication apparatus A 100 executing a program read out of a read-only memory (ROM). The IPsec communication apparatus A 100 and the IPsec communication apparatus B 110 may be information processing apparatuses such as personal computers, or maybe image forming apparatuses such as copying machines. Alternatively, the IPsec communication apparatus A 100 and the IPsec communication apparatus B 110 may be extension devices loaded in the apparatuses.

The network module 101 has the function of performing IPsec communication with an external communication apparatus such as the IPsec communication apparatus B 110 via a Local Area Network (LAN) and a Wide Area Network (WAN). Generally, this type of function includes a protocol stack based on an Open Systems Interconnection (OSI) Reference Model. Generally, a module providing an IPsec function is included in an IP layer of the protocol stack. The IKE module 102 has the function of executing an IKE protocol using the network module 101. More specifically, the IKE module 102 negotiates an ISAKMP SA (Security Association) 108 and an IPsec SA (Security Association) 109 with a communication partner.

The nonvolatile storage area 103 stores an IKE/IPsec set value 105. The IKE/IPsec set value 105 includes an IKE proposal set value and an IPsec proposal set value. The IKE proposal set value includes an encryption algorithm, a hash algorithm, an authentication method, a Diffie-Hellman (DH) group, and an effective period of the ISAKMP SA 108, which are used in the phase 2 of the IKE protocol. On the other hand, the IPsec proposal set value includes an encryption algorithm, a hash algorithm, and an effective period of the IPsec SA 109, which are used for IPsec communication. Respective pluralities of encryption algorithms, hash algorithms, and DH groups can also be selected in one proposal.

An IKE/IPsec determined value 106 includes an IKE determined value and an IPsec determined value. The IKE/IPsec determined value 106 stores, when a plurality of IKE proposal set values and a plurality of IPsec proposal set values are selected, information as to which of a plurality of candidates is to be determined as a result of IKE negotiation. For example, when the user selects AES and 3DES as a combination of encryption algorithms and MD5 and SHA-1 as a combination of hash algorithms in IPsec communication, 3DES, AES, MD5, and SHA-1 are held as IPsec proposal set values.

When a combination of AES and SHA-1 and a combination of 3DES and MD5 are selected as proposal candidates, the combinations are held as proposal candidates. As a result of performing IKE negotiation using the IPsec proposal set values, AES and SHA-1 are respectively determined as the encryption algorithm and the hash algorithm. In the case, AES and SHA-1 are held as the IKE/IPsec determined values 106.

The IKE module 102 has the function of performing negotiation using the IKE proposal set value in the phase 1 of the IKE protocol, to generate the ISKMP SA 108 which shows the consistency among the apparatuses. The IKE module 102 also has the function of generating the IPsec SA 109 which shows the consistency among the apparatuses using the IPsec proposal set value in the IK phase 2. Further, the IKE module 102 has the function of sending a deletion notification message in addition to the function of generating the ISAKMP SA 108 and the IPsec SA 109. The nonvolatile storage area 104 stores the ISAKMP SA 108 and the IPsec SA 109 generated by the IKE module 102.

The nonvolatile storage area 103 stores an IPsec SP 107. The IPsec SP 107 includes information such as an IP of a communication partner to which IPsec communication is applied and a policy relating to application/non-application of IPsec and a protocol and a port number to which IPsec is applied. Generally, an IKE proposal set value, an IPsec proposal set value, and the IPsec SP 107 are manually set.

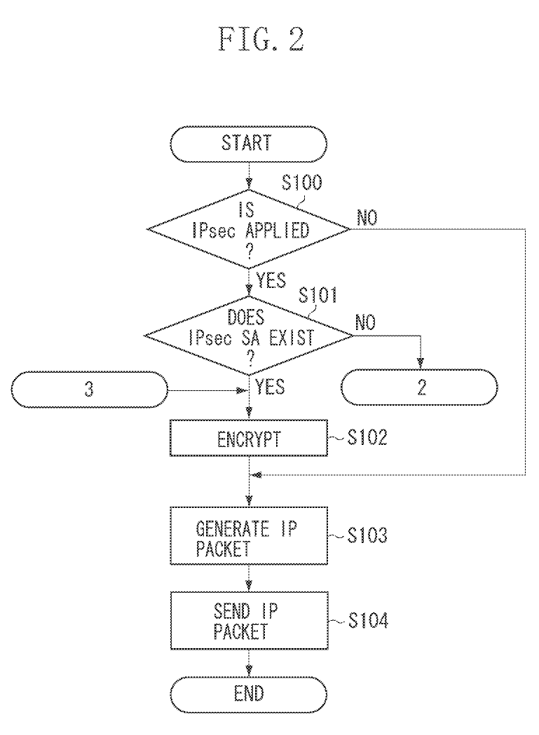

FIG. 2 is a flowchart illustrating an example of IPsec processing in an IPsec communication apparatus according to the present exemplary embodiment. An application within the IPsec communication apparatus A 100 requests the network module 101 to generate an IP packet in order to communicate with an external apparatus. In step S100, the network module 101 compares an IP address and a protocol of a destination of the IP packet with a value set in the IPsec SP 107 before generating the IP packet, and determines whether IPsec is applied to the IP packet. If it is determined that the IPsec is not applied (NO in step S100), the processing proceeds to step S103. In step S103, the network module 101 generates the IP packet. In step S104, the network module 101 sends the IP packet to an apparatus (an apparatus C) of a communication partner.

If it is determined that the IPsec is applied (YES in step S100), the processing proceeds to step S101. In step S101, the network module 101 confirms whether the corresponding IPsec SA 109 exists. If the corresponding IPsec SA 109 exists (YES in step S101), the processing proceeds to step S102. In step S102, the network module 101 encrypts a data portion of the IP packet using the IPsec SA 109. In step S103, the network module 101 generates the IP packet.

In step S104, the network module 101 then sends the generated IP packet to an apparatus (apparatus B) of a communication partner. If the IPsec SA 109 does not exist (NO in step S101), the network module 101 calls the IKE module 102 to generate the IPsec SA 109 between the network module and a communication apparatus set in the IPsec SP 107.

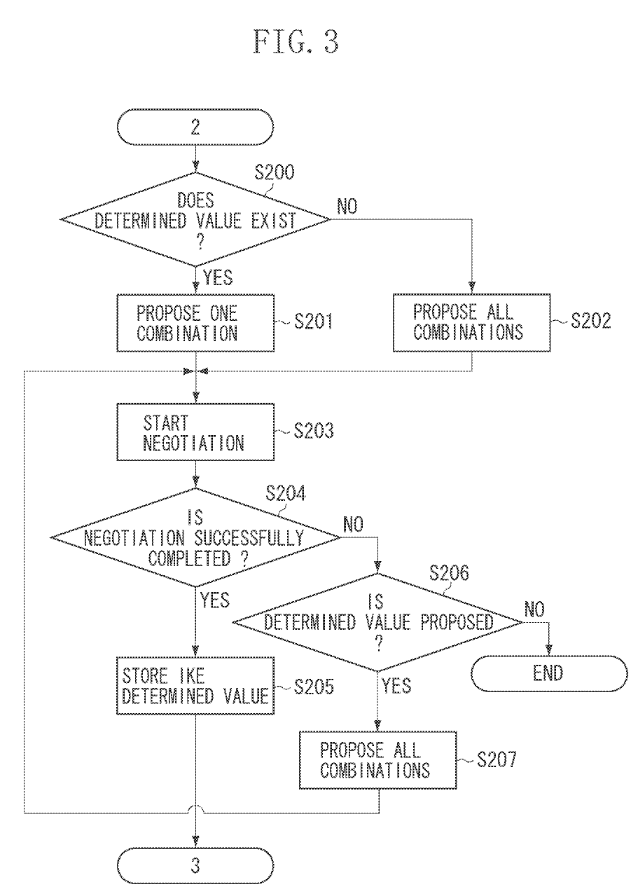

FIG. 3 is a flowchart illustrating an example of processing in the IKE phase 1 in the communication apparatus according to the present exemplary embodiment. In step S200, the IKE module 102 confirms whether an IKE determined value exists. If the IKE determined value does not exist (NO in step S200), the processing proceeds to step S202. In step S202, the IKE module 102 generates all combinations of an encryption algorithm, a hash algorithm, and a Diffie-Hellman (DH) group, which can be provided by the apparatus itself. For example, all the combinations of AES, 3DES, SHA-1, DH Group 1, and DH Group 2, which can be provided, include a combination of AES, SHA-1, and DH Group 1, a combination of AES, SHA-1, and DH group 2, a combination of 3DES, SHA-1, and DH Group 1, and a combination of 3DES, SHA-1, and DH Group 2.

In step S203, the IKE module 102 then starts negotiation using all the combinations. If the IKE determined value exists (YES in step S200), the processing proceeds to step S201. In step S201, the IKE module 102 generates a proposal of one of the combinations, which relates to the IKE determined value. In step S203, the IKE module 102 starts the negotiation.

If a key is updated again after the ISAKMP SA 108 is generated once by the processing, the number of candidates to be proposed can be reduced to a minimum necessary, and a packet size during the proposal can be suppressed to a small value. The number of candidates to be proposed can be thus reduced so that the number of times of processing on the receiving side of the proposal is reduced.

After starting the negotiation in step S203, in step S204, the IKE module 102 confirms whether the negotiation is terminated, and whether it has succeeded in generating the ISAKMP SA 108. If the ISAKMP SA 108 has been successfully generated, the processing proceeds to step S205. In step S205, the IKE module 102 extracts the encryption algorithm, the hash algorithm, and the DH Group from the ISAKMP SA 108, and stores them as an IKE determined value.

If the previous IKE determined value exists, the IKE module 102 updates the value. If the ISAKMP SA 108 has not been successfully generated (NO in step S204), the processing proceeds to step S206. In step S206, the IKE module 102 confirms whether the candidate proposed in the negotiation is a proposal candidate generated from the IKE determined value.

If the candidate proposed in the negotiation is the proposal candidate generated from the IKE determined value (YES in step S206), the processing proceeds to step S207. In step S207, the IKE module 102 generates a proposal from all the combinations. In step S203, the IKE module 102 starts the negotiation. Even if an IKE proposal set value 105 of the IPsec communication partner is changed from the previous value by the processing, the IKE module 102 can update the IKE determined value of the apparatus itself, to prevent the unsuccessful negotiation. If the candidate proposed in the negotiation is not the proposal candidate generated from the IKE determined value (NO in step S206), the IKE module 102 terminates the IKE processing.

While the processing in the IKE phase 1 has been described with reference to FIG. 3, processing can also be performed in the IKE phase 2 in a similar flow, although they differ in use of an IPsec proposal set value and an IPsec determined value. The description of the details is not repeated. The IKE module 102 performs the processing in the IKE phase 1 and the IKE phase 2, to finally generate the IPsec SA 109.

A second exemplary embodiment will be described below. In the first exemplary embodiment, it is determined in step S200 whether the IKE determined value exists, and the IKE determined value or all the combinations of the encryption algorithm, the hash algorithm, and the DH Group is/are used as the proposal candidate. A proposal determination method in the first exemplary embodiment is referred to as an “automatic setting system”. On the other hand, a system in which a user manually sets a proposal candidate, which is used in an IPsec communication apparatus, is referred to as a “manual setting system”. The automatic setting system and the manual setting system may be selectable according to designation by the user.

The automatic setting system includes a method for continuing to propose one proposal candidate until the one proposal candidate has been successfully generated in addition to a method for proposing all combinations in step S202 in the first exemplary embodiment at one time. All combinations of AES, 3DES, SHA-1, DH Group 1, and DH Group 2, which can be provided, are a combination of AES, SHA-1, and DH Group 1, a combination of AES, SHA-1, and DH Group 2, a combination of 3DES, SHA-1, and DH Group 1, and a combination of 3DES, SHA-1, and DH Group 2.

In the first exemplary embodiment, the four proposal candidates, described above, are proposed to a counterpart at one time. In the second exemplary embodiment, a combination of AES, SHA-1, and DH Group 1 is first proposed. If the combination has been unsuccessfully proposed, a combination of AES, SHA-1, and DH Group 2 is proposed. Further, if the combination has been unsuccessfully proposed, a combination of 3DES, SHA-1, and DH Group 1 is proposed. The proposal is repeated until the combination is successfully proposed or the proposal of all the proposal candidates is completed.

In the present invention, a user can also select a method for proposing all combinations of proposal candidates at one time or a method for repeating a proposal until the combination is successfully proposed.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-228651 filed Sep. 30, 2009, which is hereby incorporated by reference herein in its entirety.

What is claimed is:

1. An apparatus comprising:
a communication unit configured to perform IPsec communication; and
an execution unit configured to perform negotiation for generating IPsec SA; and
wherein the execution unit includes
a negotiation unit configured to perform a negotiation by proposing all combinations of an encryption algorithm, a hash algorithm, and a DH group to a counter apparatus, and
an extracting unit configured to extract a combination, which is selected by the counter apparatus, out of all the combinations in a case where it has succeeded in generating the IPsec SA by the negotiation, and
a storage unit configured to store the extracted combination as an IKE determined value, and
wherein the communication unit performs IPsec communication with the counter apparatus using the encryption algorithm, the hash algorithm, and the DH group.

2. The apparatus according to claim 1, wherein the negotiation unit proposes the combination, which relates to the IKE determined value, to the counter apparatus in a case where the storage unit stores the IKE determined value, and proposes all the combinations to the counter apparatus in a case where the storage unit does not store the IKE determined value.

3. The apparatus according to claim 1, further comprising
a selecting unit configured to select the combination or all the combinations, which is/are set by the user, and to be proposed to the counter apparatus according to designation by the user.

4. A method for controlling an apparatus for performing IPsec communication, and performing negotiation for generating IPsec SA, the method comprising:
performing the negotiation by proposing all combinations of an encryption algorithm, a hash algorithm, and a DH group to a counter apparatus;
extracting a combination, which is selected by the counter apparatus, out of all the combinations in a case where the IPsec SA has been successfully generated by the negotiation;
storing the extracted combination as an IKE determined value; and
performing IPsec communication with the counter apparatus using the encryption algorithm, the hash algorithm, and the DH group.

5. The method according to claim 4, further comprising:
proposing the combination, which relates to the IKE determined value, to the counter apparatus in a case where the storing stores the IKE determined value; and
proposing all the combinations to the counter apparatus in a case where the storing does not store the IKE determined value.

6. The method according to claim 4, further comprising selecting the combination or all the combinations, which is/are set by the user, and to be proposed to the counter apparatus according to designation by the user.

7. A computer readable storage medium for storing a computer program for controlling an apparatus comprising a communication unit configured to perform IPsec communication, and an execution unit configured to perform negotiation for generating IPsec SA, the computer program comprising:
a code for a negotiation unit to perform the negotiation by proposing all combinations of an encryption algorithm, a hash algorithm, and a DH group to a counter apparatus;
a code for an extracting unit to extract a combination, which is selected by the counter apparatus, out of all the combinations in a case where it has succeeded in generating the IPsec SA by the negotiation;
a code for a storage unit to store the extracted combination as an IKE determined value; and
a code for the communication unit to perform IPsec communication with the counter apparatus using the encryption algorithm, the hash algorithm, and the DH group.

8. The computer readable storage medium according to claim 7, further comprising a code for the negotiation unit to propose the combination, which relates to the IKE determined value, to the counter apparatus in a case where the storage unit stores the IKE determined value, and to propose all the combinations to the counter apparatus in a case where the storage unit does not store the IKE determined value.

9. The computer readable storage medium according to claim 7, further comprising a code for a selecting unit to select the combination or all the combinations, which is/are set by the user, and to be proposed to the counter apparatus according to designation by the user.
